(19) United States
(12) Patent Application Publication
(10) Pub. No.: US 2025/0337148 A1
(43) Pub. Date: Oct. 30, 2025

(54) DIRECTIONAL COUPLER, RADIO FREQUENCY MODULE, AND COMMUNICATION DEVICE

(71) Applicant: Murata Manufacturing Co., Ltd., Kyoto (JP)

(72) Inventor: Ikumi TOKUDA, Kyoto (JP)

(21) Appl. No.: 19/194,084

(22) Filed: Apr. 30, 2025

(30) Foreign Application Priority Data
Apr. 30, 2024 (JP) 2024-073826

(51) Int. Cl. H01P 5/18; H01P 1/18; H01P 1/213

(52) U.S. Cl. CPC H01P 5/18; H01P 1/18; H01P 1/213

(57) ABSTRACT

A directional coupler includes a main line, a first sub-line, a second sub-line, and a phase shifter circuit. The phase shifter circuit is connected in series between the first sub-line and the second sub-line. The phase shifter circuit 5 includes a first inductor, a second inductor, and a capacitor. The first inductor and the second inductor are connected between the first sub-line and the second sub-line, and are connected in series to each other. The capacitor is connected between the ground and a connection point between the first inductor and the second inductor. First coupling between the first inductor and the second inductor is greater, in magnitude, than each of second coupling between the first inductor and the main line and third coupling between the second inductor and the main line.

### CROSS REFERENCE TO RELATED APPLICATION

This application claims priority from Japanese Patent Application No. 2024-073826, filed on Apr. 30, 2024. The content of this application is incorporated herein by reference in its entirety.

### BACKGROUND OF THE DISCLOSURE

### 1. Field of the Disclosure

The present disclosure relates to a directional coupler, a radio frequency module, and a communication device. In more detail, the present disclosure relates to a directional coupler including a phase shifter circuit connected between a first sub-line and a second sub-line, a radio frequency module including the directional coupler, and a communication device including the radio frequency module.

### 2. Description of the Related Art

A directional coupler described in International Publication No. 2023/127694 includes a main line, a first sub-line, a second sub-line, and a phase shifter circuit. The first sub-line and the second sub-line are connected in series to each other through the phase shifter circuit. The phase shifter circuit, which is connected between the first sub-line and the second sub-line, achieves reduction of loss of a high-frequency-band signal, which passes through the main line, in detection of a low-frequency-band signal.

### BRIEF SUMMARY OF THE DISCLOSURE

In the directional coupler described in International Publication No. 2023/127694, the phase shifter circuit includes an inductor connected in series to the first sub-line and the second sub-line. The inductor disposed near the main line causes magnetic field coupling to occur between the inductor and the main line. The magnetic field coupling between the inductor and the main line causes a change of the impedance of the phase shifter circuit on the high frequency side, resulting in degradation of the directivity of the directional coupler.

The present disclosure is made in view of the problem, and a possible benefit thereof is to provide a directional coupler, a radio frequency module, and a communication device which achieve improvement of the directivity by suppressing a change of the impedance of the phase shifter circuit on the high frequency side.

A directional coupler according to an aspect of the present disclosure includes a main line, a first sub-line, a second sub-line, and a phase shifter circuit. The first sub-line and the second sub-line are connected in series to each other. The phase shifter circuit is connected in series between the first sub-line and the second sub-line. The phase shifter circuit includes a first inductor, a second inductor, and a capacitor. The first inductor and the second inductor are connected between the first sub-line and the second sub-line, and are connected in series to each other. The capacitor is connected between the ground and a connection point between the first inductor and the second inductor. The first inductor and the second inductor are coupled to each other and also to the main line. First coupling between the first inductor and the second inductor is greater, in magnitude, than each of second coupling between the first inductor and the main line and third coupling between the second inductor and the main line.

A directional coupler according to an aspect of the present disclosure includes a main line, a first sub-line, a second sub-line, and a phase shifter circuit. The first sub-line and the second sub-line are connected in series to each other. The phase shifter circuit is connected in series between the first sub-line and the second sub-line. The phase shifter circuit includes a first inductor, a second inductor, and a capacitor. The first inductor and the second inductor are connected between the first sub-line and the second sub-line, and are connected in series to each other. The capacitor is connected between the ground and a connection point between the first inductor and the second inductor. The main line, the first sub-line, the second sub-line, the first inductor, the second inductor, and the capacitor are included in the same substrate. Each of the distance between the first inductor and the main line and the distance between the second inductor and the main line is longer than the distance between the first inductor and the second inductor.

A radio frequency module according to an aspect of the present disclosure includes the directional coupler, an antenna terminal, multiple filters, and an antenna switch. The antenna switch switches between connection and non-connection between a signal path, which leads to the antenna terminal, and the filters. The main line of the directional coupler forms a segment of the signal path.

A communication device according to an aspect of the present disclosure includes the radio frequency module and a signal processing circuit. The signal processing circuit is connected to the radio frequency module, and performs signal processing on a radio frequency signal.

The directional coupler, the radio frequency module, and the communication device according to the aspects of the present disclosure have an advantage that a change of the impedance of the phase shifter circuit on the high frequency side may be suppressed to improve the directivity.

### BRIEF DESCRIPTION OF THE SEVERAL VIEWS OF THE DRAWINGS

FIG. 1 is a configuration diagram of a directional coupler in a first mode according to a first embodiment;

FIG. 2 is a configuration diagram of the directional coupler in a second mode;

FIG. 3 is a configuration diagram illustrating the state in which a phase shifter circuit is electromagnetically coupled with a main line;

FIG. 4 is a perspective view of the layered structure of a directional coupler according to a second embodiment;

FIG. 5 is a perspective view of the layered structure of a directional coupler according to a third embodiment;

FIG. 6 is a perspective view of the layered structure of a directional coupler according to a fourth embodiment;

FIG. 7 is a perspective view of the layered structure of a directional coupler according to a fifth embodiment; and

FIG. 8 is a configuration diagram of an example of a communication device and a radio frequency module according to a sixth embodiment.

### DETAILED DESCRIPTION OF THE DISCLOSURE

A directional coupler, a radio frequency module, and a communication device according to first to sixth embodiments will be described below by referring to the drawings.

### 1 First Embodiment

### 1-1 Overview of Directional Coupler

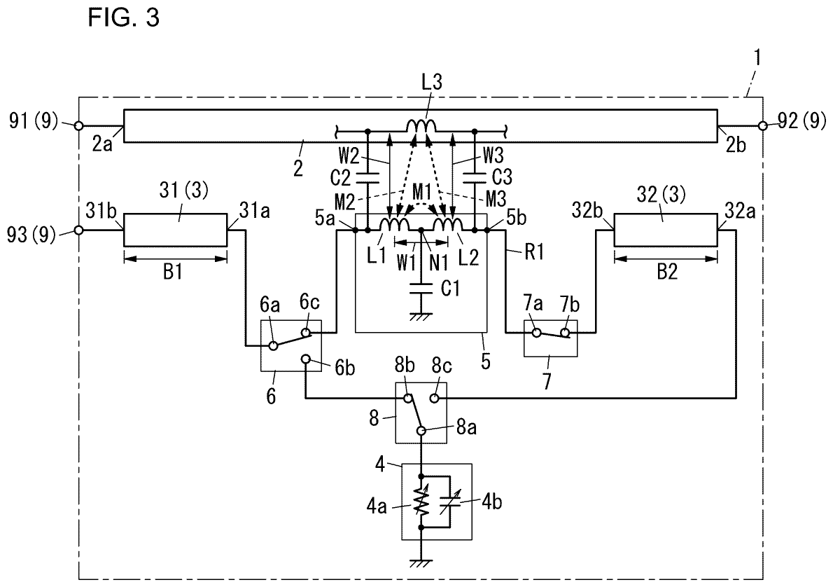

An overview of a directional coupler 1 according to the first embodiment will be described by referring to FIG. 3. As illustrated in FIG. 3, the directional coupler 1 includes a main line 2, a first sub-line 31, a second sub-line 32, and a phase shifter circuit 5. The first sub-line 31 and the second sub-line 32 are connected in series to each other. The phase shifter circuit 5 is connected in series between the first sub-line 31 and the second sub-line 32. The phase shifter circuit 5 includes a first inductor L1, a second inductor L2, and a capacitor C1. The first inductor L1 and the second inductor L2 are connected between the first sub-line 31 and the second sub-line 32, and are connected in series to each other. The capacitor C1 is connected between the ground and a connection point Ni between the first inductor L1 and the second inductor L2. The first inductor L1 and the second inductor L2 are coupled to each other and also to the main line 2. First coupling M1 between the first inductor L1 and the second inductor L2 is greater, in magnitude, than each of second coupling M2 between the first inductor L1 and the main line 2 and third coupling M3 between the second inductor L2 and the main line 2.

According to the configuration, the first coupling M1 is greater, in magnitude, than each of the second coupling M2 and the third coupling M3, achieving suppression of a change of the impedance of the phase shifter circuit 5 on the high frequency side. As a result, the directivity of the phase shifter circuit 5 may be improved.

### 1-2 Details of the Directional Coupler

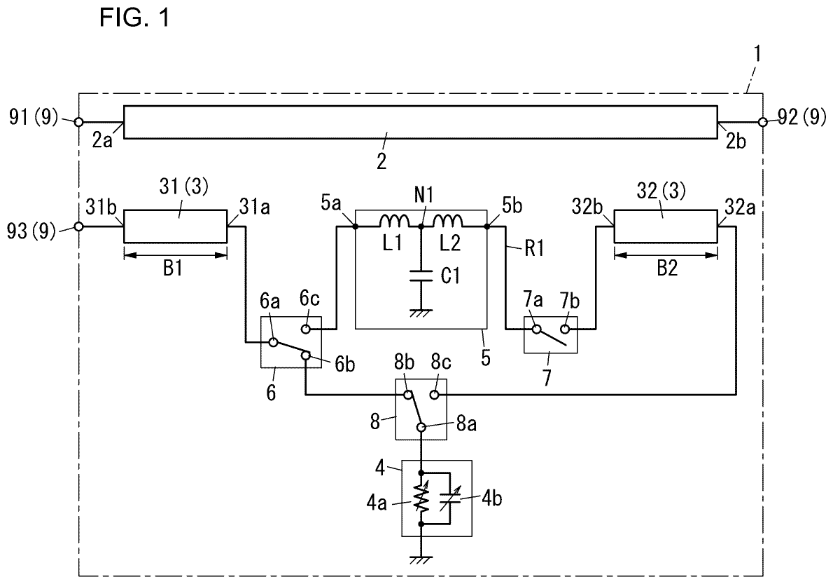

The directional coupler 1 according to the first embodiment will be described in detail by referring to FIG. 1.

The directional coupler 1 is used, for example, in a radio frequency module of a communication device. The radio frequency module is compatible, for example, with the 4th generation mobile communication (4G) standard, the 5th generation mobile communication (5G) standard, and Wi-Fi®. As illustrated in FIG. 1, the directional coupler 1 is a device which extracts, as a detection signal, a portion of a radio frequency signal, which flows through a segment (the main line 2) of a signal path in the radio frequency module, from a sub-line 3 which is electromagnetically coupled with the main line 2. Monitoring the detection signal enables monitoring a radio frequency signal flowing through the main line 2. The directional coupler 1 will be described below in detail.

As illustrated in FIG. 1, the directional coupler 1 includes the main line 2, the sub-line 3, a termination circuit 4, the phase shifter circuit 5, a first selector switch 6, a second selector switch 7, and a termination switch 8. The directional coupler 1 further includes multiple (three in the illustrated example) connection terminals 9.

The connection terminals 9 are terminals which are connectable to external circuits (not illustrated). The connection terminals 9 include first to third connection terminals 91 to 93. The first connection terminal 91 functions as an input/output terminal, for example, which inputs, to the main line 2, a radio frequency signal from an antenna terminal and which outputs, to the antenna terminal, a radio frequency signal from the main line 2. The second connection terminal 92 functions as an input/output terminal, for example, which inputs, to the main line 2, a radio frequency signal from an external circuit and which outputs, to the external circuit, a radio frequency signal from the main line 2. The third connection terminal 93 functions as a coupling terminal which outputs, for example, to an external circuit, a detection signal extracted from the sub-line 3.

The main line 2 is a line through which a radio frequency signal to be detected flows. The main line 2 has a first end 2a and a second end 2b which are both ends in the longitudinal direction of the main line 2. The first end 2a of the main line 2 is connected to the first connection terminal 91. The second end 2b of the main line 2 is connected to the second connection terminal 92. The main line 2 has an inductor L3 (hereinafter referred to as a third inductor L3) (see FIG. 3). The third inductor L3 has, for example, a parasitic inductance formed in the main line 2.

The sub-line 3 is a line which is electromagnetically coupled with the main line 2 and from which a portion of a radio frequency signal, which flows through the main line 2, is extracted as a detection signal. The sub-line 3 has the first sub-line 31 and the second sub-line 32.

The first sub-line 31 has a first end 31a and a second end 31b which are both ends in the longitudinal direction of the first sub-line 31. The first end 31a of the first sub-line 31 is connected to a common terminal 6a (described below) of the first selector switch 6. The second end 31b of the first sub-line 31 is connected to the third connection terminal 93. The first sub-line 31 is electromagnetically coupled with the main line 2.

The second sub-line 32 has a first end 32a and a second end 32b which are both ends in the longitudinal direction of the second sub-line 32. The first end 32a of the second sub-line 32 is connected to a selection terminal 8c (described below) of the termination switch 8. The second end 32b of the second sub-line 32 is connected to a terminal 7b (described below) of the second selector switch 7. Like the first sub-line 31, the second sub-line 32 is electromagnetically coupled to the main line 2.

The first sub-line 31 and the second sub-line 32 are aligned in the longitudinal direction of the main line 2. The length B1 of the first sub-line 31 and the length B2 of the second sub-line 32 may be the same or may be different from each other. In the first embodiment, the length B1 of the first sub-line 31 and the length B2 of the second sub-line 32 are the same.

In a first mode, only the first sub-line 31 between the first sub-line 31 and the second sub-line 32 is used as the sub-line 3. In the first mode, only the second sub-line 32 between the first sub-line 31 and the second sub-line 32 may be used as the sub-line 3. In a second mode, both the first sub-line 31 and the second sub-line 32 are used as the sub-line 3. In more detail, in the second mode, a series circuit in which the phase shifter circuit 5 is connected between the first sub-line 31 and the second sub-line 32 is used as the sub-line 3.

The termination circuit 4 is a circuit for terminating either one of the first sub-line 31 and the second sub-line 32. In more detail, the termination circuit 4 terminates the first sub-line 31 in the first mode. In the second mode, the termination circuit 4 terminates the second sub-line 32 in the series circuit in which the first sub-line 31, the phase shifter circuit 5, and the second sub-line 32 are connected in series in this order. The termination circuit 4 has a variable resistor 4a and a variable capacitor 4b. The variable resistor 4a is connected between a common terminal 8a of the termination switch 8 and the ground. The variable capacitor 4b is connected in parallel to the variable resistor 4a. That is, the variable capacitor 4b is also connected between the common terminal 8a of the termination switch 8 and the ground.

Adjustment of the resistance value of the variable resistor 4a and the capacitance value of the variable capacitor 4b enables adjustment of characteristics (for example, the directivity) of the directional coupler 1. In more detail, in the present embodiment, in the second mode, the phase shifter circuit 5, which is connected between the first sub-line 31 and the second sub-line 32, may cause a change in characteristics (for example, the directivity) of the directional coupler 1. Adjustment of the resistance value of the variable resistor 4a and the capacitance value of the variable capacitor 4b enables the change in characteristics of the directional coupler 1 to be alleviated. Instead of the variable resistor 4a, the termination circuit 4 may have a resistor having a fixed resistance value. Instead of the variable capacitor 4b, the termination circuit 4 may have a capacitor having a fixed capacitance value.

The phase shifter circuit 5, which is connected between the first sub-line 31 and the second sub-line 32 which are used as the sub-line 3, is a circuit for adjusting the phase of the sub-line 3 in the second mode. That is, the phase shifter circuit 5 adjusts the phase of the sub-line 3 in the second mode to suppress leak of a high-frequency signal from the main line 2 to the sub-line 3.

That is, when the phase shifter circuit 5 is connected in series to multiple sub-lines (the first sub-line 31 and the second sub-line 32) for detection, the phase shifter circuit 5 alleviates loss of a signal on the high frequency side among signals flowing through the main line 2. The phase shifter circuit 5 is disposed on a signal path R1 between the first end 31a of the first sub-line 31 and the second end 32b of the second sub-line 32. In more detail, the phase shifter circuit 5 has a first end 5a and a second end 5b. The first end 5a of the phase shifter circuit 5 is connected to a selection terminal 6c of the first selector switch 6. The second end 5b of the phase shifter circuit 5 is connected to a terminal 7a of the second selector switch 7.

The phase shifter circuit 5 has, for example, the first inductor L1, the second inductor L2, and the capacitor C1. That is, the phase shifter circuit 5 has a low-pass filter including the first inductor L1, the second inductor L2, and the capacitor C1. The first inductor L1 and the third inductor L3 are connected in series between both ends (the first end 5a and the second end 5b) of the phase shifter circuit 5. The first inductor L1 and the third inductor L3 are connected in series to each other. The capacitor C1 is connected between the ground and the connection point Ni between the first inductor L1 and the second inductor L2.

As illustrated in FIG. 3, the first inductor L1 and the second inductor L2 of the phase shifter circuit 5 are magnetically coupled to each other. This magnetic field coupling is illustrated as the first coupling M1. The phase shifter circuit 5 is electromagnetically coupled to the main line 2. In more detail, the first inductor L1 of the phase shifter circuit 5 is magnetically coupled to the third inductor L3 of the main line 2. This magnetic field coupling is illustrated as the second coupling M2. The second inductor L2 of the phase shifter circuit 5 is magnetically coupled to the third inductor L3 of the main line 2. This magnetic field coupling is illustrated as the third coupling M3. The first coupling M1 between the first inductor L1 and the second inductor L2 is greater, in magnitude, than each of the second coupling M2 between the first inductor L1 and the third inductor L3 and the third coupling M3 between the second inductor L2 and the third inductor L3. Thus, as described below, a change of the impedance of the phase shifter circuit 5 on the high frequency side may be suppressed, resulting in improvement of the directivity of the phase shifter circuit 5.

In the first embodiment, the main line 2, the first sub-line 31, the second sub-line 32, the first inductor L1, the second inductor L2, and the capacitor C1 are included in the same substrate. As illustrated in FIG. 3, each of the distance W2 (hereinafter referred to as the second distance W2) between the first inductor L1 and the main line 2 and the distance W3 (hereinafter referred to as the third distance W3) between the second inductor L2 and the main line 2 is greater than the distance W1 (hereinafter referred to as the first distance W1) between the first inductor L1 and the second inductor L2. Typically, magnetic field coupling between A and B is made smaller as the distance between A and B is made longer, and is made larger as the distance between A and B is made shorter. Therefore, the state in which each of the second distance W2 and the third distance W3 is longer than the first distance W1 causes the first coupling M1 to be greater, in magnitude, than each of the second coupling M2 and the third coupling M3.

As illustrated in FIG. 1, the first selector switch 6 and the second selector switch 7 are switches for switching between the first mode, in which only the first sub-line 31 is used as the sub-line 3, and the second mode, in which both the first sub-line 31 and the second sub-line 32 are used as the sub-line 3. That is, the first selector switch 6 and the second selector switch 7 are switches for switching the line length of the sub-line 3 to the two stages.

The first selector switch 6, which is disposed between the first sub-line 31 and the phase shifter circuit 5, switches between connection and non-connection between the first sub-line 31 and the phase shifter circuit 5. The first selector switch 6 has the common terminal 6a and multiple (two in the illustrated example) selection terminals 6b and 6c. The common terminal 6a is connected to the first end 31a of the first sub-line 31. The selection terminal 6b is connected to a selection terminal 8b of the termination switch 8. The selection terminal 6c is connected to the first end 5a of the phase shifter circuit 5.

The first selector switch 6 connects the common terminal 6a to the selection terminal 6b in the first mode, and connects the common terminal 6a to the selection terminal 6c in the second mode (that is, does not connect the common terminal 6a to the selection terminal 6b). Thus, the first sub-line 31 is connected to the termination circuit 4 in the first mode; the first sub-line 31 is connected to the phase shifter circuit 5 in the second mode.

The second selector switch 7, which is disposed between the phase shifter circuit 5 and the second sub-line 32, switches between connection and non-connection between the phase shifter circuit 5 and the second sub-line 32. The second selector switch 7 has the two terminals 7a and 7b. The terminal 7a is connected to the second end 5b of the phase shifter circuit 5. The terminal 7b is connected to the second end 32b of the second sub-line 32.

The second selector switch 7 does not connect the terminal 7a to the terminal 7b in the first mode, and connects the terminal 7a to the terminal 7b in the second mode. Thus, the phase shifter circuit 5 is not connected to the second sub-line 32 in the first mode; the phase shifter circuit 5 is connected to the second sub-line 32 in the second mode.

The termination switch 8 is a switch for switching the connection destination of the termination circuit 4 to either one of the first sub-line 31 and the second sub-line 32. The termination switch 8 has the common terminal 8a and the multiple (two in the illustrated example) selection terminals 8b and 8c. The common terminal 8a is connected to the termination circuit 4. The selection terminal 8b is connected to the selection terminal 6b of the first selector switch 6. The selection terminal 8c is connected to the first end 32a of the second sub-line 32.

The termination switch 8 connects the common terminal 8a to the selection terminal 8b in the first mode, and connects the common terminal 8a to the selection terminal 8c in the second mode. Thus, the first sub-line 31 is connected to the termination circuit 4 in the first mode; the second sub-line 32 is connected to the termination circuit 4 in the second mode.

The directional coupler 1 has the first mode and the second mode. The first mode is a mode in which a signal in a first frequency band among radio frequency signals flowing through the main line 2 is detected. The second mode is a mode in which a signal in a second frequency band among radio frequency signals flowing through the main line 2 is detected. The first frequency band corresponds, for example, to a frequency band of 1 GHz to 3 GHz (that is, middle band (MB) and high band (HB)); the second frequency band corresponds, for example, to a frequency band less than 1 GHz (that is, low band (LB)). That is, the first frequency band is a band having frequency higher than that of the second frequency band. In the directional coupler 1, the first mode is the HB mode corresponding to MB and HB, and the second mode is the LB mode corresponding to LB.

The directional coupler 1 uses the first sub-line 31 as the sub-line 3 in the first mode, and uses the series circuit, in which the phase shifter circuit 5 is connected between the first sub-line 31 and the second sub-line 32, as the sub-line 3 in the second mode.

### 1-3 Operations

### 1-3-1 First Mode

As illustrated in FIG. 1, in the first mode, the directional coupler 1 connects the common terminal 8a to the selection terminal 8b in the termination switch 8, connects the common terminal 6a to the selection terminal 6b in the first selector switch 6, and does not connect the terminal 7a to the terminal 7b in the second selector switch 7. Thus, the first sub-line 31 is connected between the third connection terminal 93 (that is, the coupling terminal) and the termination circuit 4. Thus, only the first sub-line 31 between the first sub-line 31 and the second sub-line 32 is used as the sub-line 3. The line length of the sub-line 3 in this case is the same as the line length B1 of the first sub-line 31.

In the first mode, the directional coupler 1 extracts a portion of a first signal of the first frequency band among radio frequency signals, which flow through the main line 2, from the sub-line 3 (that is, the first sub-line 31) as a detection signal, and outputs the detection signal from the third connection terminal 93 to an external device (for example, a detector).

### 1-3-2 Second Mode

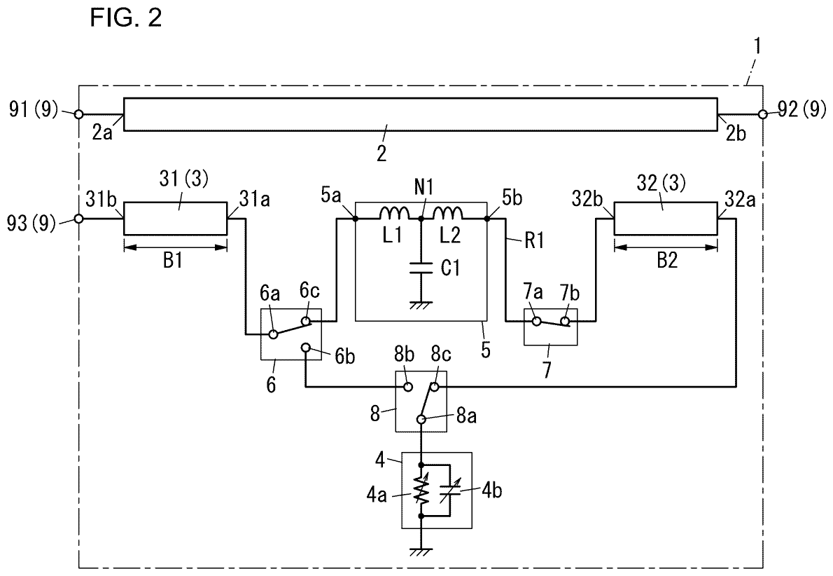

As illustrated in FIG. 2, in the second mode, the directional coupler 1 connects the common terminal 8a to the selection terminal 8c in the termination switch 8, connects the common terminal 6a to the selection terminal 6c in the first selector switch 6, and connects the terminal 7a to the terminal 7b in the second selector switch 7. Thus, the first sub-line 31 and the second sub-line 32 are connected in series to each other, and the phase shifter circuit 5 is connected in series between the first sub-line 31 and the second sub-line 32. The series circuit including the first sub-line 31, the second sub-line 32, and the phase shifter circuit 5 is connected between the third connection terminal 93 (that is, the coupling terminal) and the termination circuit 4. Thus, the series circuit is used as the sub-line 3. In this case, the line length of the sub-line 3 is the sum of the line length B1 of the first sub-line 31 and the line length B2 of the second sub-line 32 (that is, B1+B2).

Thus, the line length (B1+B2) of the sub-line 3 in the second mode is longer than the line length B1 of the sub-line 3 in the first mode. As a result, in the second mode, a second signal of the second frequency band, which is a frequency band lower than that in the first mode, may be extracted from the main line 2 to the sub-line 3 as a detection signal. That is, in the second mode, the directional coupler 1 extracts a portion of a first signal of the second frequency band among radio frequency signals, which flow through the main line 2, from the sub-line 3 as a detection signal, and outputs the detection signal from the third connection terminal 93 to an external device (for example, a detector).

### 1-4 The Impedance of the Sub-Line 3

Referring to FIG. 3, suppression of a change of the impedance of the sub-line 3 will be described. As illustrated in FIG. 3, the phase shifter circuit 5 is electromagnetically coupled to the main line 2. Electromagnetic coupling between the phase shifter circuit 5 and the main line 2 causes a change of the impedance of the entire sub-line 3 (the series circuit including the first sub-line 31, the phase shifter circuit 5, and the second sub-line 32). In more detail, electromagnetic coupling between the phase shifter circuit 5 and the main line 2 causes capacitive coupling between an electric circuit on the first sub-line 31 side in the phase shifter circuit 5 and the main line 2, resulting in formation of a capacitance C2 (parasitic capacitance). Electromagnetic coupling between the phase shifter circuit 5 and the main line 2 causes capacitive coupling between an electric circuit on the second sub-line 32 side in the phase shifter circuit 5 and the main line 2, resulting in formation of a capacitance C3 (parasitic capacitance). Thus, the capacitive coupling between the phase shifter circuit 5 and the main line 2 causes magnetic field coupling between the first inductor L1 of the phase shifter circuit 5 and the third inductor L3 of the main line 2 and magnetic field coupling between the second inductor L2 of the phase shifter circuit 5 and the third inductor L3 of the main line 2. The magnetic field coupling (second coupling M2) between the first inductor L1 and the third inductor L3 and the magnetic field coupling (third coupling M3) between the second inductor L2 and the third inductor L3 increase the impedance of the entire sub-line 3 on the high frequency side.

In the phase shifter circuit 5, the first inductor L1 is magnetically coupled to the second inductor L2. The magnetic field coupling (first coupling M1) between the first inductor L1 and the second inductor L2 decreases the impedance of the phase shifter circuit 5. That is, the impedance due to the first coupling M1 cancels each of the impedance due to the second coupling M2 and the impedance due to the third coupling M3. In more detail, the impedance provided to the phase shifter circuit 5 due to the first coupling M1 is a negative impedance for the impedance provided due to the capacitor C1 to the phase shifter circuit 5. The impedance provided to the phase shifter circuit 5 due to the second coupling M2 and the third coupling M3 is a positive impedance (that is, an impedance having the opposite sign) for the impedance provided due to the capacitor C1 to the phase shifter circuit 5. In the first embodiment, the first coupling M1 is greater, in magnitude, than each of the second coupling M2 and the third coupling M3. Therefore, the first coupling M1 causes suppression (that is, alleviation) of an increase, due to the second coupling M2 and the third coupling M3, of the impedance of the entire sub-line 3 on the high frequency side, resulting in improvement of the directivity of the directional coupler 1. This achieves wideband characteristics of the directional coupler 1.

### 1-5 Effects

The directional coupler 1 according to the first embodiment includes the main line 2, the first sub-line 31, the second sub-line 32, and the phase shifter circuit 5. The first sub-line 31 and the second sub-line 32 are connected in series to each other. The phase shifter circuit 5 is connected in series between the first sub-line 31 and the second sub-line 32. The phase shifter circuit 5 includes the first inductor L1, the second inductor L2, and the capacitor C1. The first inductor L1 and the second inductor L2 are connected between the first sub-line 31 and the second sub-line 32, and are connected in series to each other. The capacitor C1 is connected between the ground and the connection point Ni between the first inductor L1 and the second inductor L2. The first inductor L1 and the second inductor L2 are coupled to each other and also to the main line 2. The first coupling M1 between the first inductor L1 and the second inductor L2 is greater, in magnitude, than each of the second coupling M2 between the first inductor L1 and the main line 2 and the third coupling M3 between the second inductor L2 and the main line 2.

According to this configuration, the first coupling M1 is greater, in magnitude, than each of the second coupling M2 and the second coupling M2. This achieves suppression of a change of the impedance of the phase shifter circuit 5 on the high frequency side, resulting in improvement of the directivity of the phase shifter circuit 5. In addition, wideband characteristics of the phase shifter circuit 5 may be obtained.

In more detail, the impedance provided to the phase shifter circuit 5 due to the second coupling M2 and the third coupling M3 is a positive impedance for the impedance provided to the phase shifter circuit 5 due to the capacitor C1. The impedance provided to the phase shifter circuit 5 due to the first coupling M1 is a negative impedance for the impedance provided to the phase shifter circuit 5 due to the capacitor C1. In the present disclosure, the first coupling M1 is greater, in magnitude, than each of the second coupling M2 and the third coupling M3. Therefore, the impedance provided due to the first coupling M1 effectively suppresses the impedance provided due to the second coupling M2 and the third coupling M3. Thus, a change of the impedance of the phase shifter circuit 5 on the high frequency side may be suppressed, resulting in improvement of the directivity of the phase shifter circuit 5.

A directional coupler according to a comparison example will be described. The directional coupler according to the comparison example has substantially the same configuration as that of the directional coupler 1 according to the first embodiment other than a point in which the directional coupler has the second coupling M2 and the third coupling M3, but not the first coupling M1. Like the directional coupler 1 according to the first embodiment, the directional coupler according to the comparison example has a configuration in which the phase shifter circuit 5 is provided with the impedance due to the second coupling M2 and the third coupling M3. Since the directional coupler according to the comparison example does not have the first coupling M1, unlike the directional coupler 1 according to the first embodiment, the phase shifter circuit 5 is not provided with the impedance due to the first coupling M1. Therefore, in the directional coupler according to the comparison example, the impedance of the phase shifter circuit 5 increases compared with the directional coupler 1 according to the first embodiment. This increase causes degradation of the directivity of the directional coupler according to the comparison example. In contrast, as described above, in addition to the second coupling M2 and the third coupling M3, the directional coupler 1 according to the first embodiment further has the first coupling M1. This enables effective suppression of the impedance, which is provided to the phase shifter circuit 5 due to the second coupling M2 and the third coupling M3, using the impedance provided to the phase shifter circuit 5 due to the first coupling M1, resulting in improvement of the directivity of the phase shifter circuit 5.

In the directional coupler 1 according to the first embodiment, the main line 2, the first sub-line 31, the second sub-line 32, the first inductor L1, the second inductor L2, and the capacitor C1 are included in the same substrate. Each of the second distance W2 between the first inductor L1 and the main line 2 and the third distance W3 between the second inductor L2 and the main line 2 is longer than the first distance W1 between the first inductor L1 and the second inductor L2. This configuration may easily implement the magnitude relationship in which the first coupling M1 is greater, in magnitude, than each of the second coupling M2 and the third coupling M3.

The directional coupler 1 according to the first embodiment includes the main line 2, the first sub-line 31, the second sub-line 32, and the phase shifter circuit 5. The first sub-line 31 and the second sub-line 32 are connected in series to each other. The phase shifter circuit 5 is connected in series between the first sub-line 31 and the second sub-line 32. The phase shifter circuit 5 includes the first inductor L1, the second inductor L2, and the capacitor C1. The first inductor L1 and the second inductor L2 are connected between the first sub-line 31 and the second sub-line 32, and are connected in series to each other. The capacitor C1 is connected between the ground and the connection point Ni between the first inductor L1 and the second inductor L2. The main line 2, the first sub-line 31, the second sub-line 32, the first inductor L1, the second inductor L2, and the capacitor C1 are included in the same substrate. Each of the second distance between the first inductor L1 and the main line 2 and the third distance between the second inductor L2 and the main line 2 is longer than the first distance W1 between the first inductor L1 and the second inductor L2.

According to this configuration, each of the second distance W2 between the first inductor L1 and the main line 2 and the third distance W3 between the second inductor L2 and the main line 2 is longer than the first distance W1 between the first inductor L1 and the second inductor L2. Therefore, the first coupling M1 may be greater, in magnitude, than each of the second coupling M2 and the second coupling M2. As a result, a change of the impedance of the phase shifter circuit 5 on the high frequency side may be suppressed, and the directivity of the phase shifter circuit 5 may be improved.

### 1-6 Modified Example

A modified example of the first embodiment will be described below. In the description below, the same components as those in the first embodiment may be designated with the same reference numerals, and repeated description may be avoided.

### 1-6-1 First Modified Example

In the first embodiment, the first inductor L1 may be formed of at least a part (for example, the entirety) of the first sub-line 31. In this case, the first inductor L1 is formed of an inductor (for example, a parasitic inductor) included in the at least a part of the first sub-line 31. In this case, the at least a part of the first sub-line 31 is included in the components of the phase shifter circuit 5. The second inductor L2 may be formed of at least a part (for example, the entirety) of the second sub-line 32. In this case, the second inductor L2 is formed of an inductor (for example, a parasitic inductor) included in the at least a part of the second sub-line 32. In this case, the at least a part of the second sub-line 32 is included in the components of the phase shifter circuit 5. Like the first embodiment, the first modified example also achieves suppression of a change of the impedance of the phase shifter circuit 5 on the high frequency side, resulting in improvement of the directivity of the phase shifter circuit

### 2 Second Embodiment

### 2-1 Configuration

In the second embodiment, an example of the structure of the directional coupler 1 according to the first embodiment (in more detail, the layout relationship among the main line 2, the first sub-line 31, and the second sub-line 32) will be described. In the description below, points different from those of the first embodiment will be mainly described, and the same configurations as those of the first embodiment are designated with the same reference numerals as those in the first embodiment, and repeated description may be avoided.

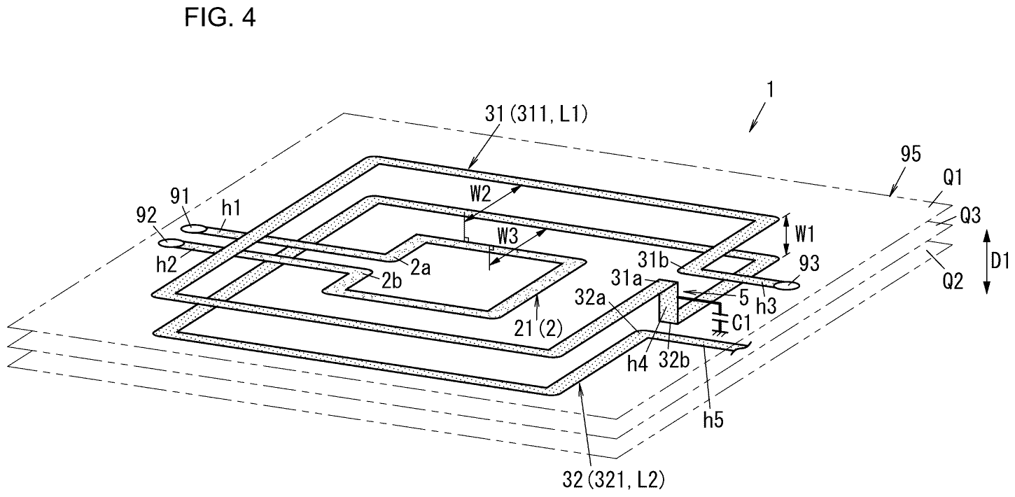

As illustrated in FIG. 4, the directional coupler 1 according to the second embodiment is the directional coupler 1 according to the first embodiment further including a substrate 95.

The substrate 95 has the main line 2, the first sub-line 31, the second sub-line 32, and the phase shifter circuit 5, which are formed thereon or therein. That is, the main line 2, the first sub-line 31, the second sub-line 32, and the phase shifter circuit 5 are formed on or in the same substrate 95. The substrate 95 is, for example, a silicon substrate. A substrate for a power amplifier and a substrate for a low-noise amplifier, which are included in a radio frequency module, are, for example, silicon substrates. When the directional coupler 1 is included in a radio frequency module, the substrate 95, which is a silicon substrate, allows the directional coupler 1 to be formed by using the same substrate (silicon substrate) together with a power amplifier(s) and a low-noise amplifier(s) which are included in the radio frequency module.

The substrate 95 is a multilayer substrate having multiple layers laminated in the thickness direction D1 of the substrate 95. The layers include three layers Q1 to Q3 which are different from each other. The layer Q1 is, for example, the top layer among the three layers Q1 to Q3. The layer Q2 is, for example, the bottom layer among the three layers Q1 to Q3. The layer Q3 is disposed between the layer Q1 and the layer Q2.

The main line 2 is disposed on the layer Q3. As described below, the first sub-line 31 is disposed on the layer Q1; the second sub-line 32 is disposed on the layer Q2. Therefore, the main line 2 is disposed on the layer Q3 between the layer Q1, on which the first sub-line 31 is formed, and the layer Q2, on which the second sub-line 32 is formed. The main line 2 is, for example, linear. In more detail, the main line 2 has a loop-shaped portion 21. The loop-shaped portion 21 is a winding line which has the first end 2a and the second end 2b and which winds once or more (in the example in FIG. 4, once). The loop-shaped portion 21 is shaped, for example, as a rectangular loop. The first end 2a of the loop-shaped portion 21 is connected to a wiring line h1. The wiring line h1 is drawn to the outer area side of the loop-shaped portion 21, and is connected to the first connection terminal 91. The second end 2b of the loop-shaped portion 21 is connected to a wiring line h2. The wiring line h2 is drawn to the outer area side of the loop-shaped portion 21, and is connected to the second connection terminal 92.

The entire first sub-line 31 forms the first inductor L1 of the phase shifter circuit 5. That is, the first inductor L1 is formed of the entire first sub-line 31. The first sub-line 31 is disposed on the layer Q1. The first sub-line 31 is, for example, linear. In more detail, the first sub-line 31 has a loop-shaped portion 311. The loop-shaped portion 311 is a winding line which has the first end 31a and the second end 31b and which winds once or more (in the example in FIG. 4, once). The loop-shaped portion 311 is shaped, for example, as a rectangular loop in plan view in the thickness direction D1. The loop-shaped portion 311 is disposed on the outer area side of the main line 2 in plan view in the thickness direction D1. That is, the main line 2 is disposed in the inner area side of the first sub-line 31 in plan view in the thickness direction D1. The first end 31a and the second end 31b are disposed, for example, on the opposite side of the first end 2a and the second end 2b of the main line 2 in plan view in the thickness direction D1. The second end 31b of the loop-shaped portion 311 is connected to a wiring line h3. The wiring line h3 is drawn to the outer area side of the loop-shaped portion 311, and is connected to the third connection terminal 93. The first end 31a of the loop-shaped portion 311 is connected to the second end 32b of a loop-shaped portion 321 (described below) of the second sub-line 32 through a wiring line h4. The wiring line h4 is disposed from the layer Q1 to the layer Q2. The first selector switch 6 is connected between the first end 31a and the wiring line h4 (not illustrated in FIG. 4).

The entire second sub-line 32 forms the second inductor L2 of the phase shifter circuit 5. That is, the second inductor L2 is formed of the entire second sub-line 32. The second sub-line 32 is formed on the layer Q3. The second sub-line 32 is disposed so as to run parallel to the first sub-line 31. The expression, “A runs parallel to B”, indicates that, when A and B are disposed on different layers, A is disposed along B so as to overlap B in the thickness direction D1, and that, when A and B are disposed on the same layer, A is disposed along B side by side.

The second sub-line 32 is, for example, linear. In more detail, the second sub-line 32 has the loop-shaped portion 321. The loop-shaped portion 321 is a winding line which has the first end 32a and the second end 32b and which winds once or more (in the example in FIG. 4, once). The first end 32a and the second end 32b are disposed, for example, on the opposite side of the first end 2a and the second end 2b of the main line 2 (that is, on the same side of the first end 31a and the second end 31b of the first sub-line 31) in plan view in the thickness direction D1. The loop-shaped portion 321 is shaped, for example, as a rectangular loop in plan view in the thickness direction D1. The loop-shaped portion 321 is shaped as a rectangle whose shape and size are, for example, the same as those of the loop-shaped portion 311 of the first sub-line 31. At least a part of the loop-shaped portion 321 and that of the loop-shaped portion 311 (in the example in FIG. 4, each entirety) overlap each other in the thickness direction D1. The loop-shaped portion 321 is disposed on the outer area side of the main line 2 in plan view in the thickness direction D1. That is, the main line 2 is disposed on the inner area side of the second sub-line 32 in plan view in the thickness direction D1. The first end 32a of the loop-shaped portion 321 is connected to a wiring line h5. The wiring line h5 is grounded through the termination switch 8 and the termination circuit 4. The second end 32b of the loop-shaped portion 321 is connected to the first end 31a of the loop-shaped portion 311 of the phase shifter circuit 5 through the wiring line h4. The second selector switch 7 is connected between the second end 32b and the wiring line h4 (not illustrated in FIG. 4). The capacitor C1 is connected between a midway of the wiring line h4 and the ground. The capacitor C1 is disposed on any of the layers of the substrate 95.

In the second embodiment, the main line 2 is disposed on the inner area side of the first sub-line 31 (that is, the first inductor L1) and the second sub-line 32 (that is, the second inductor L2) in plan view in the thickness direction D1.

In the second embodiment, the first sub-line 31 (that is, the first inductor L1) and the second sub-line 32 (that is, the second inductor L2) are magnetically coupled to each other (the first coupling); the first sub-line 31 (that is, the first inductor L1) and the main line 2 are magnetically coupled to each other (the second coupling); the second sub-line 32 (that is, the second inductor L2) and the main line 2 are magnetically coupled to each other (the third coupling).

In the second embodiment, each of the second distance W2 between the first sub-line 31 (that is, the first inductor L1) and the main line 2 and the third distance W3 between the second sub-line 32 (that is, the second inductor L2) and the main line 2 is longer than the first distance W1 between the first sub-line 31 (that is, the first inductor L1) and the second sub-line 32 (that is, the second inductor L2). Thus, the first coupling between the first inductor L1 and the second inductor L2 is greater, in magnitude, than each of the second coupling between the first inductor L1 and the main line 2 (that is, the third inductor L3) and the third coupling between the second inductor L2 and the main line 2 (that is, the third inductor L3). Thus, like the first embodiment, the first coupling causes alleviation of an increase, due to the second coupling and the third coupling, of the impedance of the entire sub-line 3 on the high frequency side, resulting in improvement of the directivity of the directional coupler 1. This achieves wideband characteristics of the directional coupler 1.

In the second embodiment, the first distance W1 between the first sub-line 31 (that is, the first inductor L1) and the second sub-line 32 (that is, the second inductor L2) is the distance between the first sub-line 31 and the second sub-line 32 in the thickness direction D1. In other words, the first distance W1 between the first sub-line 31 and the second sub-line 32 is the distance between the layer Q1, on which the first sub-line 31 is disposed, and the layer Q2, on which the second sub-line 32 is disposed. In the second embodiment, the second distance W2 between the first sub-line 31 (that is, the first inductor L1) and the main line 2 is the narrowest space among spaces between the first sub-line 31 and the main line 2 in plan view in the thickness direction D1. The space between line A and line B refers to a space between the center in the width direction of line A and the center in the width direction of line B in plan view in the thickness direction D1. Similarly, the third distance W3 between the second sub-line 32 (that is, the second inductor L2) and the main line 2 is the narrowest space among the spaces between the second sub-line 32 and the main line 2 in plan view in the thickness direction D1.

### 2-2 Effects

In the directional coupler 1 according to the second embodiment, the substrate 95 has multiple layers including the first layer Q1 and the second layer Q2 which are different from each other. The first inductor L1 is disposed on the first layer Q1. The second inductor L2 is disposed on the second layer Q2. The first inductor L1 and the second inductor L2 are disposed so as to overlap each other at least partially (in the example in FIG. 4, entirely) in the thickness direction D1 of the substrate 95. This configuration enables the first distance W1 between the first inductor L1 and the second inductor L2 in the thickness direction D1 of the substrate 95 to be easily made short. As a result, while coupling between the main line 2 and the first and second sub-lines 31 and 32 is retained, the first coupling M1 between the first inductor L1 and the second inductor L2 may be easily made large.

In the directional coupler 1 according to the second embodiment, the first inductor L1 and the second inductor L2 include the loop-shaped portions 311 and 321 which wind once or more (in the example in FIG. 4, once). This configuration enables each of the first inductor L1 and the second inductor L2 to be formed in a compact shape while the inductance of the first inductor L1 and that of the second inductor L2 are maintained.

In the directional coupler 1 according to the second embodiment, the main line 2 is disposed on the inner area side of the first inductor L1 and the second inductor L2 in plan view in the thickness direction D1 of the substrate 95. In this configuration, the first inductor L1 and the second inductor L2 are disposed on the outer area side of the main line 2. Therefore, the first inductor L1 and the second inductor L2 may be easily made large. As a result, while the coupling between the main line 2 and the first and second sub-lines 31 and 32 is maintained, the inductance of the first inductor L1 and that of the second inductor L2 may be easily made large. In addition, in plan view in the thickness direction D1 of the substrate 95, the second distance W2 between the first inductor L1 and the main line 2 and the third distance W3 between the second inductor L2 and the main line 2 may be easily ensured. As a result, while the coupling between the main line 2 and the first and second sub-lines 31 and 32 is retained, the second coupling M2 between the first inductor L1 and the main line 2 and the third coupling M3 between the second inductor L2 and the main line 2 may be easily made small.

In the directional coupler 1 according to the second embodiment, the main line 2 is disposed on the layer Q3 between the first layer Q1 and the second layer Q2 among the layers. This configuration enables balancing between the first coupling M1 and the second coupling M2 to be easily obtained. This causes the characteristics of the directional coupler 1 to be easily adjusted to desired characteristics.

### 2-3 Modified Examples

Modified examples of the second embodiment will be described below. The modified examples described below may be implemented by combining each other. In the description below, the same components as those in the second embodiment are designated with the same reference numerals, and repeated description may be avoided.

### 2-3-1 First Modified Example

In the second embodiment, the case in which the loop-shaped portions 21, 311, and 321 of the main line 2, the first sub-line 31, and the second sub-line 32 are rectangular is described. However, the shape of the loop-shaped portions 21, 311, and 321 is not limited to being rectangular, and may be, for example, circular or polygon other than quadrangular.

### 2-3-2 Second Modified Example

In the second embodiment, the case in which the loop-shaped portions 21, 311, and 321 of the main line 2, the first sub-line 31, and the second sub-line 32 wind once is described. However, the loop-shaped portions 21, 311, and 321 may wind less than once or twice or more, including a fraction of a turn. When the loop-shaped portions 21, 311, and 321 wind twice or more, each turn may be disposed on a different layer, or may be disposed on the same layer. In the case where the loop-shaped portions 21, 311, and 321 wind twice or more, when the turns are disposed on the same layer, the turns may be disposed on the inner area side sequentially, or may be disposed on the outer area side sequentially.

### 3 Third Embodiment

### 3-1 Configuration

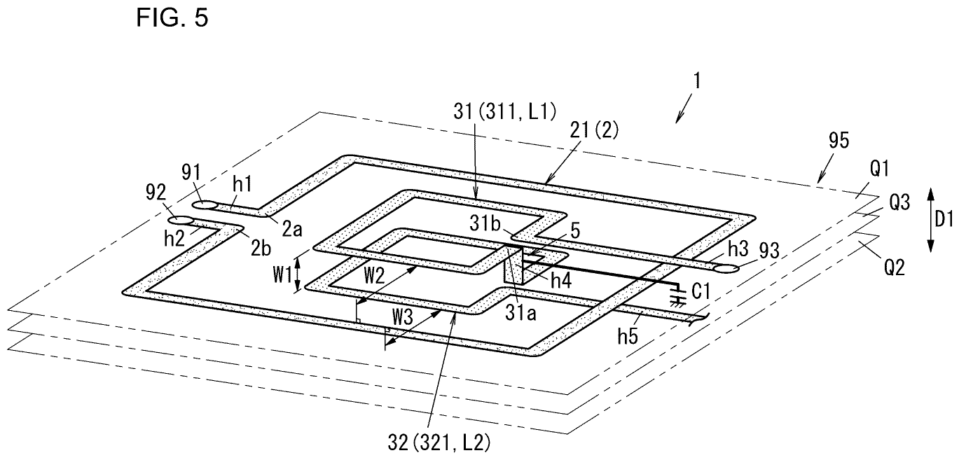

As illustrated in FIG. 5, the directional coupler 1 according to the third embodiment has substantially the same configuration as that of the directional coupler 1 according to the second embodiment other than the point in which the main line 2 is disposed on the outer area side of the first sub-line 31 (that is, the first inductor L1) and the second sub-line 32 (that is, the second inductor L2) in plan view in the thickness direction D1.

In the third embodiment, each of the second distance W2 between the first sub-line 31 (that is, the first inductor L1) and the main line 2 and the third distance W3 between the second sub-line 32 (that is, the second inductor L2) and the main line 2 is longer than the first distance W1 between the first sub-line 31 (that is, the first inductor L1) and the second sub-line 32 (that is, the second inductor L2). Thus, the first coupling between the first inductor L1 and the second inductor L2 is greater, in magnitude, than each of the second coupling between the first inductor L1 and the main line 2 (that is, the third inductor L3) and the third coupling between the second inductor L2 and the main line 2 (that is, the third inductor L3). Thus, like the first embodiment, the first coupling causes alleviation of an increase, due to the second coupling and the third coupling, of the impedance of the entire sub-line 3 on the high frequency side, resulting in improvement of the directivity of the directional coupler 1. This achieves wideband characteristics of the directional coupler 1.

Also in the third embodiment, like the case of the second embodiment, the first distance W1 between the first sub-line 31 (that is, the first inductor L1) and the second sub-line 32 (that is, the second inductor L2) is the distance between the first sub-line 31 and the second sub-line 32 in the thickness direction D1. In other words, the first distance W1 is a space between the layer Q1, on which the first sub-line 31 is disposed, and the layer Q2, on which the second sub-line 32 is disposed. Also in the third embodiment, like the case of the second embodiment, the second distance W2 between the first sub-line 31 (that is, the first inductor L1) and the main line 2 is the narrowest space among the spaces between the first sub-line 31 and the main line 2 in plan view in the thickness direction D1. Similarly, the third distance W3 between the second sub-line 32 (that is, the second inductor L2) and the main line 2 is the narrowest space among the spaces between the second sub-line 32 and the main line 2 in plan view in the thickness direction D1.

### 3-2 Effects

In the directional coupler 1 according to the third embodiment, the main line 2 is disposed on the outer area side of the first inductor L1 and the second inductor L2 in plan view in the thickness direction D1 of the substrate 95. According to this configuration, the main line 2 allows suppression of electromagnetic influence on the first inductor L1 and the second inductor L2 from a circuit on the outer area side. In plan view in the thickness direction D1 of the substrate 95, the second distance W2 between the first inductor L1 and the main line 2 and the third distance W3 between the second inductor L2 and the main line 2 may be easily ensured. As a result, the second coupling M2 between the first inductor L1 and the main line 2 and the third coupling M3 between the second inductor L2 and the main line 2 may be easily made small.

### 4 Fourth Embodiment

### 4-1 Configuration

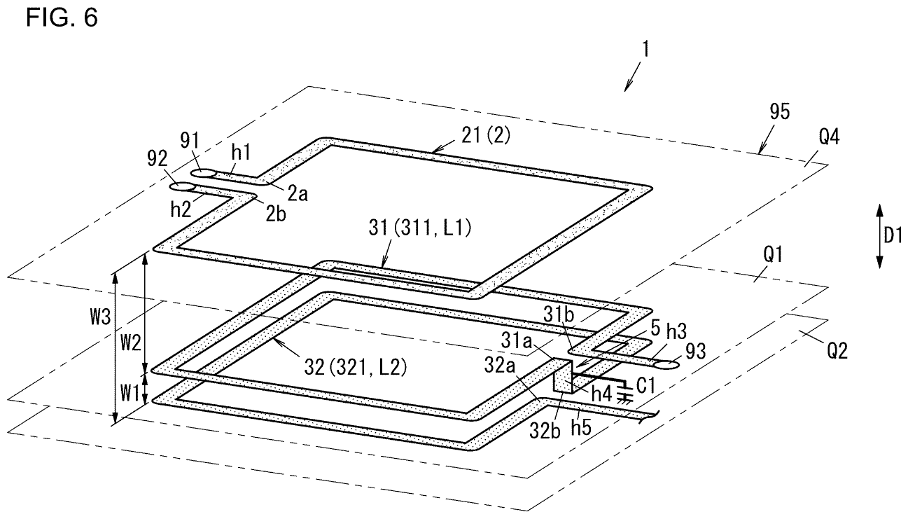

As illustrated in FIG. 6, the directional coupler 1 according to the fourth embodiment has substantially the same configuration as that of the directional coupler 1 according to the second embodiment other than the point in which the main line 2 is disposed on a layer Q4 on the opposite side of the layer Q2 (second layer) with respect to the layer Q1 (first layer), among the layers.

In the fourth embodiment, the loop-shaped portion 21 of the main line 2 has a shape (for example, rectangular) of the same shape and size as those of the loop-shaped portion 311 of the first sub-line 31 and the loop-shaped portion 321 of the second sub-line 32. The main line 2 (that is, the loop-shaped portion 21) is disposed so as to run parallel to the first sub-line 31 (that is, the loop-shaped portion 311). The main line 2 (that is, the loop-shaped portion 21) and the first sub-line 31 (that is, the loop-shaped portion 311) overlap each other at least partially (in the example in FIG. 6, entirely) in the thickness direction D1.

In the fourth embodiment, each of the second distance W2 between the first sub-line 31 (that is, the first inductor L1) and the main line 2 and the third distance W3 between the second sub-line 32 (that is, the second inductor L2) and the main line 2 is longer than the first distance W1 between the first sub-line 31 (that is, the first inductor L1) and the second sub-line 32 (that is, the second inductor L2). Thus, the first coupling between the first inductor L1 and the second inductor L2 is greater, in magnitude, than each of the second coupling between the first inductor L1 and the main line 2 (that is, the third inductor L3) and the third coupling between the second inductor L2 and the main line 2 (that is, the third inductor L3). Thus, like the first embodiment, the first coupling causes alleviation of an increase, due to the second coupling and the third coupling, of the impedance of the entire sub-line 3 on the high frequency side, resulting in improvement of the directivity of the directional coupler 1. This achieves wideband characteristics of the directional coupler 1.

Also in the fourth embodiment, like the case of the second embodiment, the first distance W1 between the first sub-line 31 (that is, the first inductor L1) and the second sub-line 32 (that is, the second inductor L2) is the distance between the first sub-line 31 and the second sub-line 32 in the thickness direction D1. In other words, the first distance W1 is a space between the layer Q1, on which the first sub-line 31 is disposed, and the layer Q2, on which the second sub-line 32 is disposed. In the fourth embodiment, the second distance W2 between the first sub-line 31 (that is, the first inductor L1) and the main line 2 is the distance between the first sub-line 31 and the main line 2 in the thickness direction D1. In other words, the second distance W2 is a space between the layer Q1, on which the first sub-line 31 is disposed, and the layer Q4, on which the main line 2 is disposed. Similarly, the third distance W3 between the second sub-line 32 (that is, the second inductor L2) and the main line 2 is the distance between the second sub-line 32 and the main line 2 in the thickness direction D1. In other words, the third distance W3 is a space between the layer Q2, on which the second sub-line 32 is disposed, and the layer Q4, on which the main line 2 is disposed.

### 4-2 Effects

In the directional coupler 1 according to the fourth embodiment, the main line 2 is disposed on the layer Q4 on the opposite side of the second layer Q2 with respect to the first layer Q1, among the layers. According to this configuration, the first distance W1 between the first inductor L1 and the second inductor L2 may be easily made short in the thickness direction D1 of the substrate 95, enabling the first coupling M1 to be easily made large. In the thickness direction D1 of the substrate 95, the second distance W2 between the main line 2 and the first inductor L1 and the third distance W3 between the main line 2 and the second inductor L2 may be easily made short, enabling the second coupling M2 and the third coupling M3 to be easily made small. As a result, the first coupling M1 may be easily made greater, in magnitude, than each of the second coupling M2 and the third coupling M3.

### 4-3 Modified Example

A modified example of the fourth embodiment will be described below. In the description below, the same components as those in the fourth embodiment are designated with the same reference numerals, and repeated description may be avoided.

In the fourth embodiment, the case in which the main line 2 is disposed on the layer Q4 on the opposite side of the layer Q2 (second layer) with respect to the layer Q1 (first layer) among the layers is described. However, the main line 2 may be disposed on a layer on the opposite side of the layer Q1 (first layer) with respect to the layer Q2 (second layer), among the layers. The modified example also exerts substantially the same effects as those of the fourth embodiment.

### 5 Fifth Embodiment

### 5-1 Configuration

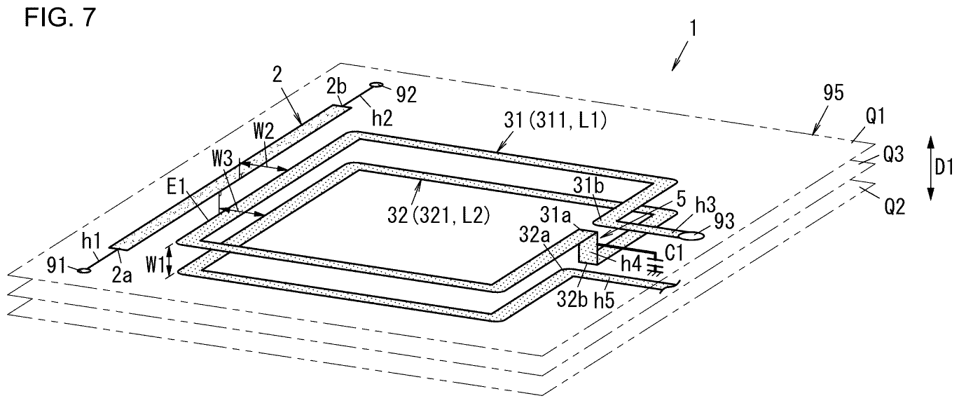

As illustrated in FIG. 7, the directional coupler 1 according to the fifth embodiment has substantially the same configuration as that of the directional coupler 1 according to the second embodiment other than the point in which the main line 2 is formed in a straight-line shape and is disposed on the outer area side of the first sub-line 31 and the second sub-line 32.

In the fifth embodiment, the main line 2 is formed in a straight-line shape. In plan view in the thickness direction D1, the main line 2 is disposed along a side E1 of the loop-shaped portion 311 of the first sub-line 31 with a space from the side E1.

In the fifth embodiment, each of the second distance W2 between the first sub-line 31 (that is, the first inductor L1) and the main line 2 and the third distance W3 between the second sub-line 32 (that is, the second inductor L2) and the main line 2 is longer than the first distance W1 between the first sub-line 31 (that is, the first inductor L1) and the second sub-line 32 (that is, the second inductor L2). Thus, the first coupling between the first inductor L1 and the second inductor L2 is greater, in magnitude, than each of the second coupling between the first inductor L1 and the main line 2 (that is, the third inductor L3) and the third coupling between the second inductor L2 and the main line 2 (that is, the third inductor L3). Thus, like the first embodiment, the first coupling causes alleviation of an increase, due to the second coupling and the third coupling, of the impedance of the entire sub-line 3 on the high frequency side, resulting in improvement of the directivity of the directional coupler 1. This achieves wideband characteristics of the directional coupler 1.

Also in the fifth embodiment, like the case of the second embodiment, the first distance W1 between the first sub-line 31 (that is, the first inductor L1) and the second sub-line 32 (that is, the second inductor L2) is the distance between the first sub-line 31 and the second sub-line 32 in the thickness direction D1. In other words, the first distance W1 is a space between the layer Q1, on which the first sub-line 31 is disposed, and the layer Q2, on which second sub-line 32 is disposed. In the fifth embodiment, the second distance W2 between the first sub-line 31 (that is, the first inductor L1) and the main line 2 is the narrowest space among the spaces between the first sub-line 31 and the main line 2 in plan view in the thickness direction D1. Similarly, the third distance W3 between the second sub-line 32 (that is, the second inductor L2) and the main line 2 is the narrowest space among the spaces between the second sub-line 32 and the main line 2 in plan view in the thickness direction D1.

### 5-2 Effects

In the directional coupler 1 according to the fifth embodiment, the main line 2 is shaped in a straight line. The main line 2 is disposed on the outer area side of the first inductor L1 and the second inductor L2 in plan view in the thickness direction D1. This configuration enables each of the second distance W2 between the main line 2 and the first inductor L1 and the third distance W3 between the main line 2 and the second inductor L2 to be easily made longer than the first distance W1 between the first inductor L1 and the second inductor L2 when the main line 2 is shaped in a straight line. As a result, the first coupling M1 may be easily made greater, in magnitude, than each of the second coupling M2 and the third coupling M3.

### 5-3 Modified Example

Modified examples of the fifth embodiment will be described below. In the description below, the same components as those in the fifth embodiment are designated with the same reference numerals, and repeated description may be avoided.

### 5-3-1 First Modified Example

In the fifth embodiment, the case in which the main line 2 is disposed on the layer Q3 between the layer Q1, on which the first sub-line 31 is disposed, and the layer Q2, on which the second sub-line 32 is disposed, is described. However, the main line 2 may be disposed on a layer on the opposite side of the layer Q2 with respect to the layer Q1, or may be disposed on a layer on the opposite side of the layer Q1 with respect to the layer Q2. The first modified example also exerts substantially the same effects as those of the fifth embodiment.

### 6 Sixth Embodiment

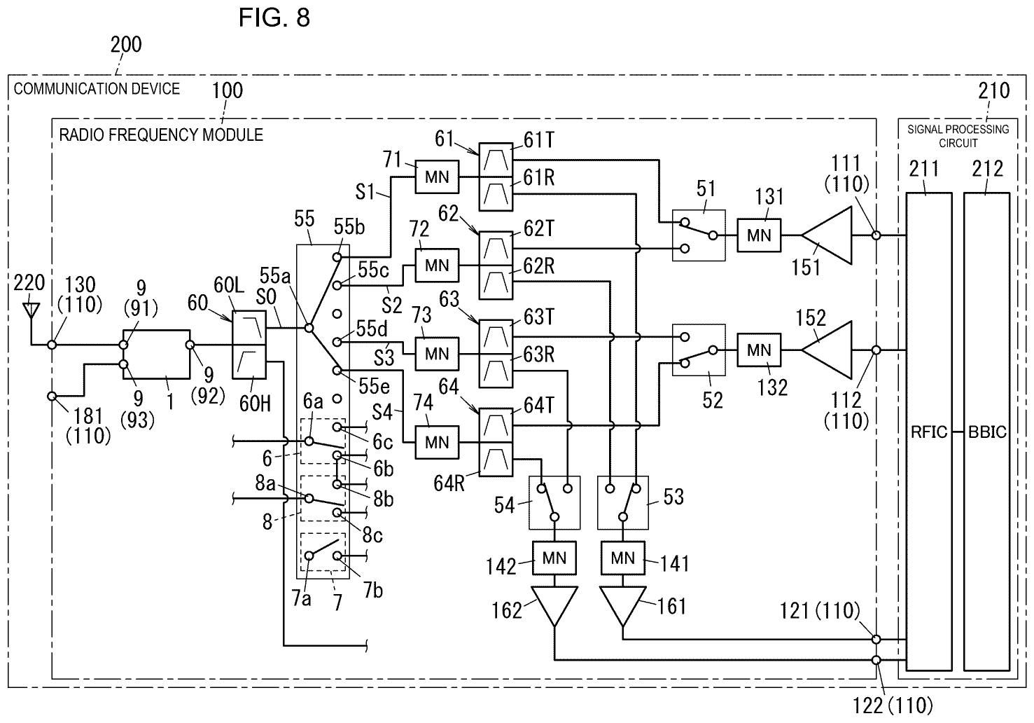

Referring to FIG. 8, a radio frequency module 100 and a communication device 200 according to the sixth embodiment will be described. The radio frequency module 100 according to the sixth embodiment is an exemplary radio frequency module including the directional coupler 1 according to any one of the first to fifth embodiments (for example, the first embodiment). The communication device 200 according to the sixth embodiment is an exemplary communication device including the radio frequency module 100.

### 6-1 The Configuration of the Communication Device

The communication device 200 is, for example, a mobile terminal (for example, a smartphone) or a wearable terminal (for example, a smartwatch). The communication device 200 includes the radio frequency module 100, a signal processing circuit 210, and an antenna 220.

The radio frequency module 100 is compatible, for example, with the 4G standard, the 5G standard, and Wi-Fi®. The radio frequency module 100 extracts a receive signal of a predetermined frequency band from receive signals received at the antenna 220, and amplifies the receive signal for outputting to the signal processing circuit 210. The radio frequency module 100 amplifies a transmit signal, which is outputted from the signal processing circuit 210, to convert it to a transmit signal of a predetermined frequency band for outputting from the antenna 220.

The signal processing circuit 210, which is connected to the radio frequency module 100, performs signal processing on radio frequency signals. In more detail, the signal processing circuit 210 performs signal processing on receive signals which are outputted from the radio frequency module 100, and performs signal processing on transmit signals for outputting to the radio frequency module 100. The signal processing circuit 210 includes a radio frequency (RF) signal processing circuit 211 and a baseband signal processing circuit 212.

The RF signal processing circuit 211 is, for example, a radio frequency integrated circuit (RFIC). The RF signal processing circuit 211 performs signal processing such as down-converting on receive signals, which are outputted from the radio frequency module 100, for outputting to the baseband signal processing circuit 212. The RF signal processing circuit 211 performs signal processing such as upconverting on transmit signals, which are outputted from the baseband signal processing circuit 212, for outputting to the radio frequency module 100. The baseband signal processing circuit 212 is, for example, a baseband integrated circuit (BBIC). The baseband signal processing circuit 212 outputs receive signals, which are outputted from the RF signal processing circuit 211, to the outside. The baseband signal processing circuit 212 generates transmit signals from baseband signals (for example, audio signals and image signals), which are inputted from the outside, and outputs the generated transmit signals to the RF signal processing circuit 211.

### 6-2 The Configuration of the Radio Frequency Module

The radio frequency module 100 includes multiple external connection terminals 110, power amplifiers 151 and 152, low-noise amplifiers 161 and 162, transmit filters 61T to 64T, receive filters 61R to 64R, output matching circuits 131 and 132, matching circuits 141 and 142, matching circuits 71 to 74, switches 51 to 55, a diplexer 60, and the directional coupler 1 (coupler).

The external connection terminals 110 include an antenna terminal 130, two signal input terminals 111 and 112, two signal output terminals 121 and 122, and a coupler output terminal 181. The antenna terminal 130 is connected to the antenna 220. The two signal input terminals 111 and 112 are terminals for receiving transmit signals from the signal processing circuit 210, and are connected to output units of the signal processing circuit 210. The two signal output terminals 121 and 122 are terminals for outputting, to the signal processing circuit 210, transmit signals from the radio frequency module 100, and are connected to input units of the signal processing circuit 210. The coupler output terminal 181 is a terminal for outputting, to the outside (for example, the signal processing circuit 210), a detection signal extracted by the directional coupler 1.

The power amplifiers 151 and 152 each have an input unit and an output unit. The input units of the power amplifiers 151 and 152 are connected to the signal input terminals 111 and 112; the output units of the power amplifiers 151 and 152 are connected to the common terminals of the switches 51 and 52 through the output matching circuits 131 and 132. The power amplifiers 151 and 152 amplify transmit signals, which are received from the signal input terminals 111 and 112, respectively, and output the amplified signals to the common terminals of the switches 51 and 52 through the output matching circuits 131 and 132, respectively.

The switch 51 has the common terminal and two selection terminals (a first selection terminal and a second selection terminal). The common terminal of switch 51 is connected to the power amplifier 151 through the output matching circuit 131. The two selection terminals of the switch 51 are connected to the respective input units of the transmit filters 61T and 62T. The switch 51 selectively outputs an output signal from the power amplifier 151, to either one of the transmit filters 61T and 62T. The switch 52 has the common terminal and two selection terminals (a first selection terminal and a second selection terminal). The common terminal of the switch 52 is connected to the power amplifier 152 through the output matching circuit 132. The two selection terminals of the switch 52 are connected to the respective input units of the transmit filters 63T and 64T. The switch 52 selectively outputs an output signal from the power amplifier 152, to either one of the transmit filters 63T and 64T.

The transmit filter 61T has the input unit and an output unit. The input unit of the transmit filter 61T is connected to the first selection terminal of the switch 51; the output unit of the transmit filter 61T is connected to the switch 55 through the matching circuit 71. The transmit filter 61T passes a transmit signal in the transmit band of the first communication band among transmit signals which have been amplified by the power amplifier 151. The transmit filter 62T has the input unit and an output unit. The input unit of the transmit filter 62T is connected to the second selection terminal of the switch 51; the output unit of the transmit filter 62T is connected to the switch 55 through the matching circuit 72. The transmit filter 62T passes a transmit signal in the transmit band of the second communication band among transmit signals which have been amplified by the power amplifier 151.

The transmit filter 63T has the input unit and an output unit. The input unit of the transmit filter 63T is connected to the first selection terminal of the switch 52; the output unit of the transmit filter 63T is connected to the switch 55 through the matching circuit 73. The transmit filter 63T passes a transmit signal in the transmit band of the third communication band among transmit signals which have been amplified by the power amplifier 152. The transmit filter 64T has the input unit and an output unit. The input unit of the transmit filter 64T is connected to the second selection terminal of the switch 52; the output unit of the transmit filter 64T is connected to the switch 55 through the matching circuit 74. The transmit filter 64T passes a transmit signal in the transmit band of the fourth communication band among transmit signals which have been amplified by the power amplifier 152.

The low-noise amplifiers 161 and 162 each have an input unit and an output unit. The input units of the low-noise amplifiers 161 and 162 are connected to the common terminals of the switches 53 and 54 through the matching circuits 141 and 142, respectively. The output units of the low-noise amplifiers 161 and 162 are connected to the signal output terminals 121 and 122. The low-noise amplifiers 161 and 162 amplify receive signals, which are outputted from the switches 53 and 54, for outputting to the signal output terminals 121 and 122, respectively.

The switch 53 has the common terminal and two selection terminals (a first selection terminal and a second selection terminal). The common terminal of the switch 53 is connected to the low-noise amplifier 161 through the matching circuit 141; the two selection terminals of the switch 53 are connected to the respective output units of the receive filters 61R and 62R. The switch 53 selectively outputs, to the low-noise amplifier 161, a receive signal from either one of the receive filters 61R and 62R. The switch 54 has the common terminal and two selection terminals (a first selection terminal and a second selection terminal). The common terminal of the switch 54 is connected to the low-noise amplifier 162 through the matching circuit 142; the two selection terminals of the switch 54 are connected to the respective output units of the receive filters 63R and 64R. The switch 54 selectively outputs, to the low-noise amplifier 162, a receive signal from either one of the receive filters 63R and 64R.

The receive filter 61R has an input unit and the output unit. The input unit of the receive filter 61R is connected to a selection terminal of the switch 55 through the matching circuit 71; the output unit of the receive filter 61R is connected to the first selection terminal of the switch 53. The receive filter 61R passes a receive signal in the receive band of the first communication band among transmit signals which are outputted from the switch 55. The receive filter 62R has an input unit and the output unit. The input unit of the receive filter 62R is connected to a selection terminal of the switch 55 through the matching circuit 72; the output unit of the receive filter 62R is connected to the second selection terminal of the switch 53. The receive filter 62R passes a receive signal in the receive band of the second communication band among transmit signals which are outputted from the switch 55.

The receive filter 63R has an input unit and the output unit. The input unit of the receive filter 63R is connected to a selection terminal of the switch 55 through the matching circuit 73; the output unit of the receive filter 63R is connected to the first selection terminal of the switch 54. The receive filter 63R passes a receive signal in the receive band of the third communication band among receive signals which are outputted from the switch 55. The receive filter 64R has an input unit and the output unit. The input unit of the receive filter 64R is connected to a selection terminal of the switch 55 through the matching circuit 74; the output unit of the receive filter 64R is connected to the second selection terminal of the switch 54. The receive filter 64R passes a receive signal in the receive band of the fourth communication band among receive signals which are outputted from the switch 55.

The output matching circuit 131, which is connected between the output unit of the power amplifier 151 and the common terminal of the switch 51, matches the impedance between the power amplifier 151 and the transmit filters 61T and 62T. The output matching circuit 132, which is connected between the output unit of the power amplifier 152 and the common terminal of the switch 52, matches the impedance between the power amplifier 152 and the transmit filters 63T and 64T. The matching circuit 141, which is connected between the input unit of the low-noise amplifier 161 and the common terminal of the switch 53, matches the impedance between the low-noise amplifier 161 and the receive filters 61R and 62R. The matching circuit 142, which is connected between the input unit of the low-noise amplifier 162 and the common terminal of the switch 54, matches the impedance between the low-noise amplifier 162 and the receive filters 63R and 64R.

The matching circuit 71, which is connected between a selection terminal 55b (described below) of the switch 55 and the output unit of the transmit filter 61T and between the selection terminal 55b and the input unit of the receive filter 61R, matches the impedance between the switch 55 and the transmit filter 61T and between the switch 55 and the receive filter 61R. The matching circuit 72, which is connected between a selection terminal 55c (described below) of the switch 55 and the output unit of the transmit filter 62T and between the selection terminal 55c and the input unit of the receive filter 62R, matches the impedance between the switch 55 and the transmit filter 62T and between the switch 55 and the receive filter 62R. The matching circuit 73, which is connected between a selection terminal 55d (described below) of the switch 55 and the output unit of the transmit filter 63T and between the selection terminal 55d and the input unit of the receive filter 63R, matches the impedance between the switch 55 and the transmit filter 63T and between the switch 55 and the receive filter 63R. The matching circuit 74, which is connected between a selection terminal 55e (described below) of the switch 55 and the output unit of the transmit filter 64T and between the selection terminal 55e and the input unit of the receive filter 64R, matches the impedance between the switch 55 and the transmit filter 64T and between the switch 55 and the receive filter 64R.

The diplexer 60 has a first filter 60L and a second filter 60H. The first filter 60L is a filter using, as the passband, a frequency range including the first to fourth frequency bands. The second filter 60H is a filter using, as the passband, a frequency range including different frequency bands other than the first to fourth frequency bands. Each of the first filter 60L and the second filter 60H has two input/output units (a first input/output unit and a second input/output unit). The first input/output units of the first filter 60L and the second filter 60H are connected to the antenna terminal 130 through the directional coupler 1. The second input/output unit of the first filter 60L is connected to the common terminal of the switch 55. Hereinafter, the first input/output unit of the first filter 60L and the first input/output unit of the second filter 60H may be collectively referred to “the first input/output unit of the diplexer 60”.

The directional coupler 1 has substantially the same configuration as that of the directional coupler 1 of the first embodiment. The directional coupler 1 extracts, as a detection signal, a portion of a radio frequency signal (receive signal), which flows through a segment (the main line 2) of a signal path between the antenna terminal 130 and the first input/output unit of the diplexer 60, from the sub-line 3 which is electromagnetically coupled to the main line 2. The directional coupler 1 outputs the extracted detection signal to the outside (for example, the signal processing circuit 210) of the radio frequency module 100 through the coupler output terminal 181.

Like the directional coupler 1 according to the first embodiment, the directional coupler 1 according to the present embodiment includes the main line 2, the first and second sub-lines 31 and 32, the termination circuit 4, the phase shifter circuit 5, the first selector switch 6, the second selector switch 7, the termination switch 8, and the connection terminals 91 to 93.

The first selector switch, the second selector switch 7, and the termination switch 8 are disposed in the switch 55 to be integrated with the switch 55. The connection terminal 91 is connected to the antenna terminal 130, and the connection terminal 92 is connected to the first input/output unit of the diplexer 60. That is, the main line 2 of the directional coupler 1 forms a segment of a signal path between the antenna terminal 130 and the diplexer 60. The connection terminal 93 is connected to the coupler output terminal 181.

The switch 55, which is an antenna switch, is, for example, formed of a switch integrated circuit (IC). The switch 55 switches between connection and non-connection between a signal path S0, which leads to the antenna terminal 130, and each of signal paths Si to S4, which lead to duplexers 61 to 64 (filters). That is, the switch 55 switches between connection and non-connection between the signal path S0, which leads to the antenna terminal 130, and the duplexers 61 to 64 (filters). As described above, the switch 55 is integrated with the first selector switch 6, the second selector switch 7, and the termination switch 8.

In more detail, the switch 55 includes a common terminal 55a, the selection terminals 55b, 55c, 55d, and 55e, the common terminal 6a and the two selection terminals 6b and 6c of the first selector switch 6, the two terminals 7a and 7b of the second selector switch 7, and the common terminal 8a and the two selection terminals 8b and 8c of the termination switch 8.

The common terminal 55a of the switch 55 is connected to the second input/output unit of the first filter 60L. The selection terminals 55b, 55c, 55d, and 55e of the switch 55 are connected to the first input/output units of the duplexers 61 to 64 through the matching circuits 71 to 74, respectively. The common terminal 6a of the switch 55 is connected to the first end 31a (see FIG. 1) of the first sub-line 31 of the directional coupler 1. The selection terminal 6b of the switch 55 is connected to the selection terminal 8c of the switch 55. The selection terminal 6c of the switch 55 is connected to the first end 5a (see FIG. 1) of the phase shifter circuit 5 of the directional coupler 1. The common terminal 8a of the switch 55 is connected to the termination circuit 4 (see FIG. 1) of the directional coupler 1. The selection terminal 8b of the switch 55 is connected to the selection terminal 6b of the switch 55. The selection terminal 8c of the switch 55 is connected to the first end 32a (see FIG. 1) of the second sub-line 32 of the directional coupler 1. The terminal 7a of the switch 55 is connected to the second end 5b (see FIG. 1) of the phase shifter circuit 5 of the directional coupler 1; the terminal 7b of the switch 55 is connected to the second end 32b (see FIG. 1) of the second sub-line 32 of the directional coupler 1.

### 6-3 Effects

The radio frequency module 100 according to the sixth embodiment includes the directional coupler 1, the antenna terminal 130, the multiple filters 61 to 64, and the antenna switch 55. The antenna switch 55 switches between connection and non-connection between the signal path S0, which leads to the antenna terminal 130, and the filters 61 to 64. The main line 2 of the directional coupler 1 forms a segment of the signal path S0. This configuration may provide the radio frequency module 100 having the effects of the directional coupler 1.

The communication device 200 according to the sixth embodiment includes the radio frequency module 100 and the signal processing circuit 210. The signal processing circuit 210, which is connected to the radio frequency module 100, performs signal processing on radio frequency signals. This configuration may provide the communication device 200 having the effects of the radio frequency module 100.

The first to sixth embodiments and their modified examples may be implemented by combining these with each other.

### 7 Aspects

The aspects described below are disclosed by using the embodiments and modified examples described above.

A directional coupler (1) of a first aspect includes a main line (2), a first sub-line (31), a second sub-line (32), and a phase shifter circuit (5). The first sub-line (31) and the second sub-line (32) are connected in series to each other. The phase shifter circuit (5) is connected in series between the first sub-line (31) and the second sub-line (32). The phase shifter circuit (5) includes a first inductor (L1), a second inductor (L2), and a capacitor (C1). The first inductor (L1) and the second inductor (L2) are connected between the first sub-line (31) and the second sub-line (32), and are connected in series to each other. The capacitor (C1) is connected between the ground and a connection point (Ni) between the first inductor (L1) and the second inductor (L2). The first inductor (L1) and the second inductor (L2) are coupled to each other and also to the main line (2). First coupling (M1) between the first inductor (L1) and the second inductor (L2) is greater, in magnitude, than each of second coupling (M2) between the first inductor (L1) and the main line (2) and third coupling (M3) between the second inductor (L2) and the main line (2).

According to this configuration, the first coupling (M1) is greater, in magnitude, than each of the second coupling (M2) and the second coupling (M2). This achieves suppression of a change of the impedance of the phase shifter circuit (5) on the high frequency side, resulting in improvement of the directivity of the phase shifter circuit (5). In addition, wideband characteristics of the phase shifter circuit (5) may be obtained.

According to a directional coupler (1) of a second aspect, in the first aspect, the main line (2), the first sub-line (31), the second sub-line (32), the first inductor (L1), the second inductor (L2), and the capacitor (C1) are included in the same substrate. Each of the distance (W2) between the first inductor (L1) and the main line (2) and the distance (W3) between the second inductor (L2) and the main line (2) is longer than the distance (W1) between the first inductor (L1) and the second inductor (L2).

According to this configuration, the magnitude relationship in which the first coupling (M1) is greater, in magnitude, than each of the second coupling (M2) and the third coupling (M3) may be easily implemented.

According to a directional coupler (1) of a third aspect, in the second aspect, the first inductor (L1) is formed of at least a part of the first sub-line (31). The second inductor (L2) is formed of at least a part of the second sub-line (32).

According to this configuration, in the case in which the first inductor (L1) is formed of at least a part of the first sub-line (31) and in which the second inductor (L2) is formed of at least a part of the second sub-line (32), like the first aspect, a change of the impedance of the phase shifter circuit (5) on the high frequency side may be suppressed, resulting in improvement of the directivity of the phase shifter circuit (5).

According to a directional coupler (1) of a fourth aspect, in the third aspect, the substrate (95) has multiple layers (Q1 to Q3; Q1, Q2, and Q4) which are laminated in the thickness direction (D1) of the substrate (95). The layers (Q1 to Q3; Q1, Q2, and Q4) include a first layer (Q1) and a second layer (Q2) which are different from each other. The first inductor (L1) is disposed on the first layer (Q1). The second inductor (L2) is disposed on the second layer (Q2). The first inductor (L1) and the second inductor (L2) are disposed so as to overlap each other at least partially in the thickness direction (D1) of the substrate (95).

According to this configuration, in the thickness direction (D1) of the substrate (95), the first distance (W1) between the first inductor (L1) and the second inductor (L2) may be easily made short. As a result, while coupling between the main line (2) and the first sub-line (31) and coupling between the main line (2) and the second sub-line (32) are retained, the first coupling (M1) between the first inductor (L1) and the second inductor (L2) may be easily made large.

According to a directional coupler (1) of a fifth aspect, in the fourth aspect, the layers (Q1 to Q3) further include a third layer (Q3) disposed between the first layer (Q1) and the second layer (Q2). The main line (2) is disposed on the third layer (Q3) of the layers.

According to this configuration, balancing between the first coupling (M1) and the second coupling (M2) may be easily obtained. Thus, characteristics of the directional coupler (1) may be easily adjusted to desired characteristics.

According to a directional coupler (1) of a sixth aspect, in the fourth aspect, the main line (2) is disposed on a layer (Q4) on the opposite side of the second layer (Q2) with respect to the first layer (Q1) or on a layer on the opposite side of the first layer (Q1) with respect to the second layer (Q2), among the layers.

According to this configuration, in the thickness direction (D1) of the substrate (95), the first distance (W1) between the first inductor (L1) and the second inductor (L2) may be easily made short. Thus, the first coupling (M1) may be easily made large. In the thickness direction (D1) of the substrate (95), the second distance (W2) between the main line (2) and the first inductor (L1) and the third distance (W3) between the main line (2) and the second inductor (L2) may be easily made short. Thus, the second coupling (M2) and the third coupling (M3) may be easily made small. As a result, the first coupling (M1) may be easily made greater, in magnitude, than each of the second coupling (M2) and the third coupling (M3).

According to a directional coupler (1) of a seventh aspect, in any one of the third to sixth aspects, the first inductor (L1) and the second inductor (L2) each include a loop-shaped portion (311, 321) which winds less than once, or once or more, including a fraction of a turn.

According to this configuration, each of the first inductor (L1) and the second inductor (L2) may be formed in a compact shape while their inductance is ensured.

According to a directional coupler (1) of an eighth aspect, in the seventh aspect, the main line (2) is disposed on the inner area side of the first inductor (L1) and the second inductor (L2) in plan view in the thickness direction (D1) of the substrate (95).

According to this configuration, the first inductor (L1) and the second inductor (L2) are disposed on the outer area side of the main line (2). Therefore, the first inductor (L1) and the second inductor (L2) may be easily made large. As a result, while the coupling between the main line (2) and the first sub-line (31) and the coupling between the main line (2) and the second sub-line (32) are retained, each of the inductance of the first inductor (L1) and that of the second inductor (L2) may be easily made large. In plan view in the thickness direction (D1) of the substrate (95), the second distance (W2) between the first inductor (L1) and the main line (2) and the third distance (W3) between the second inductor (L2) and the main line (2) may be easily ensured. As a result, while the coupling between the main line (2) and the first sub-line (31) and the coupling between the main line (2) and the second sub-line (32) are retained, the second coupling (M2) between the first inductor (L1) and the main line (2) and the third coupling (M3) between the second inductor (L2) and the main line (2) may be easily made small.

According to a directional coupler (1) of a ninth aspect, in the seventh aspect, the main line (2) is disposed on the outer area side of the first inductor (L1) and the second inductor (L2) in plan view in the thickness direction (D1) of the substrate (95).

According to this configuration, the main line (2) may cause suppression of electromagnetic influence on the first inductor (L1) and the second inductor (L2) from a circuit on the outer area side. In plan view in the thickness direction (D1) of the substrate (95), the second distance (W2) between the first inductor (L1) and the main line (2) and the third distance (W3) between the second inductor (L2) and the main line (2) may be easily ensured. As a result, the second coupling (M2) between the main line (2) and the first inductor (L1) and the third coupling (M3) between the main line (2) and the second inductor (L2) may be easily made small.

According to a directional coupler (1) of a tenth aspect, in the seventh aspect, the main line (2) is shaped in a straight line. In plan view in the thickness direction (D1) of the substrate (95), the main line (2) is disposed on the outer area side of the first inductor (L1) and the second inductor (L2).

According to this configuration, in the case where the main line (2) is shaped in a straight line, the second distance (W2) between the main line (2) and the first inductor (L1) and the third distance (W3) between the main line (2) and the second inductor (L2) may be easily made larger than the first distance (W1) between the first inductor (L1) and the second inductor (L2). As a result, the first coupling (M1) may be easily made greater, in magnitude, than each of the second coupling (M2) and the third coupling (M3).

A directional coupler (1) of an eleventh aspect includes a main line (2), a first sub-line (31), a second sub-line (32), and a phase shifter circuit (5). The first sub-line (31) and the second sub-line (32) are connected in series to each other. The phase shifter circuit (5) is connected in series between the first sub-line (31) and the second sub-line (32). The phase shifter circuit (5) includes a first inductor (L1), a second inductor (L2), and a capacitor (C1). The first inductor (L1) and the second inductor (L2) are connected between the first sub-line (31) and the second sub-line (32), and are connected in series to each other. The capacitor (C1) is connected between the ground and a connection point (Ni) between the first inductor (L1) and the second inductor (L2). The main line (2), the first sub-line (31), the second sub-line (32), the first inductor (L1), the second inductor (L2), and the capacitor (C1) are included in the same substrate. Each of the distance between the first inductor (L1) and the main line (2) and the distance between the second inductor (L2) and the main line (2) is longer than the distance (W1) between the first inductor (L1) and the second inductor (L2).

According to this configuration, each of the distance (W2) between the first inductor (L1) and the main line (2) and the distance (W3) between the second inductor (L2) and the main line (2) is longer than the distance (W1) between the first inductor (L1) and the second inductor (L2). Therefore, the first coupling (M1) may be made greater, in magnitude, than each of the second coupling (M2) and the second coupling (M2). As a result, a change of the impedance of the phase shifter circuit (5) on the high frequency side may be suppressed, and the directivity of the phase shifter circuit (5) may be improved.

A radio frequency module (100) of a twelfth aspect includes the directional coupler (1) according to any one of the first to eleventh aspects, an antenna terminal (130), multiple filters (61 to 64), and an antenna switch (55). The antenna switch (55) switches between connection and non-connection between a signal path (S0), which leads to the antenna terminal (130), and the filters (61 to 64). The main line (2) of the directional coupler (1) forms a segment of the signal path (S0).

According to this configuration, the radio frequency module (100) having the effects of the directional coupler (1) may be provided.

A communication device (200) of a thirteenth aspect includes the radio frequency module (100) of the twelfth aspect and a signal processing circuit (210). The signal processing circuit (210) is connected to the radio frequency module (100) and performs signal processing on a radio frequency signal.

According to this configuration, the communication device (200) having the effects of the radio frequency module (100) may be provided.

What is claimed is:

1. A directional coupler comprising:
a main line;
a first sub-line and a second sub-line that are connected in series to each other; and
a phase shifter circuit that is connected in series between the first sub-line and the second sub-line,
wherein the phase shifter circuit comprises:
a first inductor and a second inductor that are connected between the first sub-line and the second sub-line, and that are connected in series to each other, and
a capacitor that is connected between ground and a node between the first inductor and the second inductor,
wherein the first inductor and the second inductor are coupled to each other and also coupled to the main line, and
wherein first coupling between the first inductor and the second inductor is greater in magnitude than each of second coupling between the first inductor and the main line and third coupling between the second inductor and the main line.

2. The directional coupler according to claim 1,
wherein the main line, the first sub-line, the second sub-line, the first inductor, the second inductor, and the capacitor are in an identical substrate, and
wherein each of a distance between the first inductor and the main line and a distance between the second inductor and the main line is longer than a distance between the first inductor and the second inductor.

3. The directional coupler according to claim 2,
wherein the first inductor is formed from at least a part of the first sub-line, and
wherein the second inductor is formed from at least a part of the second sub-line.

4. The directional coupler according to claim 3,
wherein the substrate has a plurality of layers which are laminated in a thickness direction of the substrate,
wherein the plurality of layers includes a first layer and a second layer which are different from each other,
wherein the first inductor is on the first layer,
wherein the second inductor is on the second layer, and
wherein the first inductor and the second inductor overlap each other at least partially in the thickness direction of the substrate.

5. The directional coupler according to claim 4,
wherein the plurality of layers further includes a third layer between the first layer and the second layer, and
wherein the main line is on the third layer.

6. The directional coupler according to claim 4, wherein the main line is on a layer on the opposite side of the second layer with respect to the first layer, or on a layer on the opposite side of the first layer with respect to the second layer.

7. The directional coupler according to claim 3, wherein the first inductor and the second inductor each have a loop-shaped portion.

8. The directional coupler according to claim 7, wherein the loop-shaped portion has less than one turn.

9. The directional coupler according to claim 7, wherein the loop-shaped portion has one turn.

10. The directional coupler according to claim 7, wherein the loop-shaped portion has more than one turn.

11. The directional coupler according to claim 7, wherein in plan view in the thickness direction of the substrate, the main line is inside the first inductor and the second inductor.

12. The directional coupler according to claim 7, wherein in plan view in the thickness direction of the substrate, the main line is outside the first inductor and the second inductor.

13. The directional coupler according to claim 7,
wherein the main line is shaped in a straight line, and
wherein in plan view in the thickness direction of the substrate, the main line is outside the first inductor and the second inductor.

14. A directional coupler comprising:
a main line;
a first sub-line and a second sub-line that are connected in series to each other; and
a phase shifter circuit that is connected in series between the first sub-line and the second sub-line,
wherein the phase shifter circuit comprises:
a first inductor and a second inductor that are connected between the first sub-line and the second sub-line and that are connected in series to each other, and
a capacitor that is connected between a ground and a connection point between the first inductor and the second inductor,
wherein the main line, the first sub-line, the second sub-line, the first inductor, the second inductor, and the capacitor are in a same substrate, and
wherein each of a distance between the first inductor and the main line and a distance between the second inductor and the main line is longer than a distance between the first inductor and the second inductor.

15. A radio frequency module comprising:
the directional coupler according to claim 1;
an antenna terminal;
a plurality of filters; and
an antenna switch configured to selectively connect a signal path to the plurality of filters, the signal path leading to the antenna terminal,
wherein the main line of the directional coupler forms a segment of the signal path.

16. A communication device comprising:
the radio frequency module according to claim 12; and
a signal processing circuit that is connected to the radio frequency module and that is configured to perform signal processing on a radio frequency signal.
